(19) United States
(12) Patent Application Publication
(10) Pub. No.: US 2013/0259547 A1
(43) Pub. Date: Oct. 3, 2013

(54) IMAGE FORMING APPARATUS

(71) Applicant: Oki Data Corporation, Minato-ku (JP)

(72) Inventor: Makoto YABUKI, Tokyo (JP)

(21) Appl. No.: 13/853,476

(22) Filed: Mar. 29, 2013

(30) Foreign Application Priority Data
Mar. 30, 2012 (JP) 2012-081842

(51) Int. Cl. G03G 15/20

(52) U.S. Cl. CPC G03G 15/2089
USPC 399/329

(57) ABSTRACT

A fixing member is rotatably supported. A first pressing member faces the fixing member. A running member runs while being sandwiched between the fixing member and the first pressing member. A first mechanism urges the first pressing member against the fixing member, defining a first nip between the fixing member and the running member. A second pressing member presses the running member against the fixing member. A second mechanism includes a holding member that holds the second pressing member and an urging member therein, and urges the second pressing member against the fixing member with the running member sandwiched therebetween, defining a second nip, adjacent to the first nip, between the fixing member and the running member. The second pressing member and the holding member abut each other through a plurality of projections formed on at least one of the second pressing member and second pressing mechanism.

### BACKGROUND OF THE INVENTION

1. Field of the Invention

The present invention relates to a fixing apparatus and an image forming apparatus that incorporates the fixing apparatus.

2. Description of the Related Art

Conventional image forming apparatus include printers, copying machines, facsimile machines, and multifunction peripherals. For example, an electrophotographic printer includes a charging roller, a photoconductive drum, a light emitting diode (LED) head, a developing roller, and a transfer roller. The charging roller uniformly charges the surface of the photoconductive drum. The LED head illuminates the charged surface of the photoconductive drum to form an electrostatic latent image in accordance with print data. The developing roller supplies a thin layer of toner to the electrostatic latent image as the photoconductive drum rotates, thereby developing the electrostatic latent image with the toner into a toner image. The transfer roller transfers the toner image onto print paper. After transfer, the print paper passes through a fixing unit so that the toner image on the print paper is fixed into a permanent image by heat and pressure. The print paper is then discharged onto a stacker.

One such printer is disclosed in Japanese Patent Application No. 2005-275371 and employs a belt-nip fixing unit in which a pressure pad is pressed against a fixing roller with an endless belt sandwiched between the pressure pad and the fixing roller.

FIG. 12 is a cross-sectional view of a conventional belt-nip fixing unit 101.

The fixing unit 101 includes a pressure belt assembly 102 and a fixing roller 103. The pressure belt assembly 102 includes a pressure roller 104, a pressure belt 105, a pressure pad 106, a spring 107, and a holder 108. The spring 107 urges the pressure pad 106 against the fixing roller 103 with the pressure belt 105 sandwiched between the pressure pad 106 and the fixing roller 103. The holder 108 holds the pressure pad 106 in position. The pressure pad 106 is supported such that the pressure pad 106 is slidable on the inner surface of the pressure belt 105 and can extend and retract within the holder 108 relative to the fixing roller 103. A heater 109 is disposed inside the fixing roller 103.

A nip N3 is formed between the fixing roller 103 and the pressure belt assembly 102. When the print paper carrying a toner image thereon passes through the nip N3, the toner image is fused by heat and is pressed by the pressure belt assembly 102, thereby being fixed into the print paper.

The conventional fixing unit 101 suffers from a problem in that when the pressure belt 105 runs, a friction resistance is developed between the inner surface of the pressure belt 105 and the upper surface of the pressure pad 106, and in that the friction resistance may cause the pressure pad 106 to decline, vibrate, or rattle. This may result in seizure of the pressure pad 106 within the holder 108, the pressure pad 106 becoming unable to reliably urge the pressure belt 105 against the fixing roller 103. The unstable urging force of the pressure pad 106 causes poor print quality such as disturbance, shifting, uneven quality of image or increases the load on the fixing motor (not shown) that drives the fixing roller 103 in rotation, or may cause complete stoppage of the fixing unit 101.

### SUMMARY OF THE INVENTION

An object of the present invention is to solve the aforementioned drawbacks of the conventional fixing unit and to provide a fixing unit capable of pressing a pressure member against a fixing member while also preventing image quality from degrading or the fixing unit from stopping.

A fixing apparatus is capable of pressing a pressure member against a fixing member while also preventing image quality from degrading or the fixing unit from stopping.

A fixing member is rotatably supported. A first pressing member is disposed to face the fixing member. A running member is sandwiched between the fixing member and the first pressing member, and runs when the fixing member rotates. A first pressing mechanism urges the first pressing member against the fixing member so that a first nip is defined between the fixing member and the running member. A second pressing member is disposed to face the fixing member with the running member sandwiched between the fixing member and the second pressing member. A second pressing mechanism urges the second pressing member against the fixing member with the running member sandwiched between the fixing member and the second pressing member so that a second nip is defined between the fixing member and the running member. The second nip is adjacent to the first nip. The second pressing mechanism includes a holding member that holds the second pressing member and an urging member therein. The urging member urges the second pressing member against the fixing member. The second pressing member and the holding member abut each other through a plurality of projections.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 illustrates a printer according to a first embodiment;

FIG. 2 is a cross-sectional view of a fixing unit according to the first embodiment;

FIG. 3 is a rear perspective view, illustrating the rear of a pressure pad as seen substantially in a direction shown by arrow E in FIG. 2;

FIG. 4 is a perspective view illustrating the front of the pressure pad as seen substantially in the opposite direction to arrow E;

FIG. 5A illustrates the operation of the fixing unit according to the first embodiment;

FIG. 5B illustrates a pertinent portion of the fixing unit;

FIG. 6 is a rear view of the pressure pad according to the second embodiment;

FIG. 7A is a cross-sectional view of a fixing unit according to a second embodiment;

FIG. 7B is an expanded view of a pertinent portion of the fixing unit according to a second embodiment;

FIG. 8A is an exploded perspective view illustrating a pressure pad, springs, and a holder according to the second embodiment;

FIG. 8B is a rear view of the pressure pad according to the second embodiment;

FIG. 9A is a cross-sectional view illustrating the pertinent portion of the fixing unit according to a third embodiment;

FIG. 9B is an expanded view of a pertinent portion of the fixing unit;

FIG. 10 is a rear view of a pressure pad according to the third embodiment;

FIG. 11 is a cross-sectional view of the pressure pad; and

FIG. 12 is a cross-sectional view of a conventional belt-nip fixing unit.

### DETAILED DESCRIPTION OF THE INVENTION

The present invention will be described in detail by way of preferred embodiments with reference to the accompanying drawings. The embodiments will be described in terms of a printer as an image forming apparatus.

### First Embodiment

### {Configuration of Image Forming Apparatus}

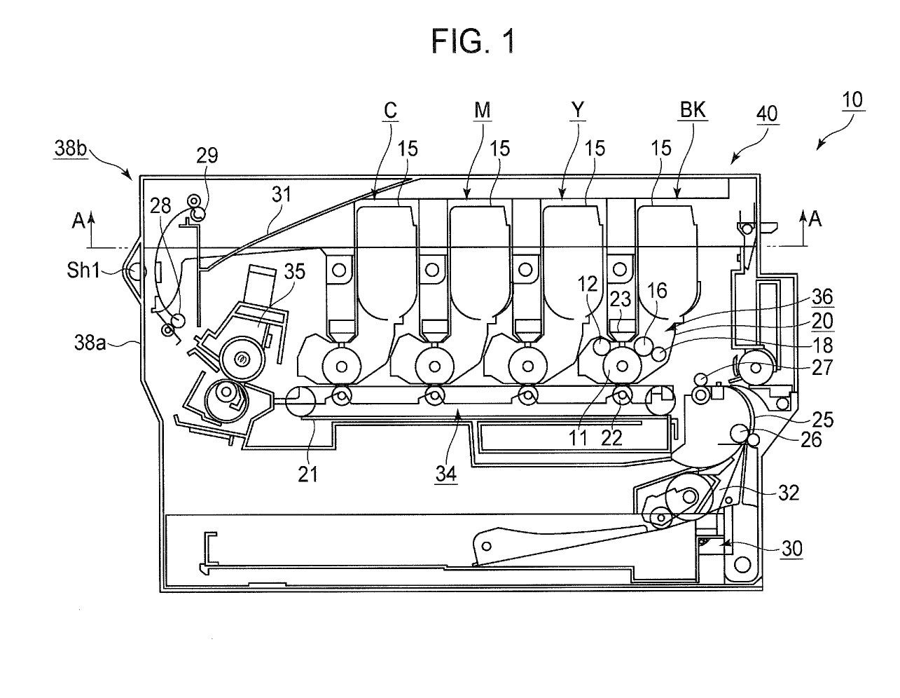

FIG. 1 illustrates a printer 10 as an image forming apparatus according to a first embodiment.

The printer 10 includes a body 40, image forming units, a transport path 25 in which print paper (not shown) as a print medium is transported, and transport rollers 26-29 in the transport path 25. The image forming units (ID units) Bk, Y, M, and C that form black, yellow, magenta, and cyan images, respectively, are aligned along the transport path 25.

A belt nip fixing unit 35 is disposed downstream of the image forming units BK, Y, M, and C, and fixes a toner image on the print paper by heat and pressure.

Each of the image forming units BK, Y, M, and C may be substantially identical; for simplicity, only the image forming apparatus BK will be described, it being understood that other image forming units Y, M, and C may work in a similar fashion.

The image forming unit BK includes a photoconductive drum 11, an LED head 23, and a developing unit 36. A charging roller 12 rotates in pressure contact with the photoconductive drum 11 in a direction opposite to the photoconductive drum 11, and uniformly charges the surface of the photoconductive drum 11. An LED head 23 is disposed above the photoconductive drum 11 and parallels the photoconductive drum 11. The LED head 23 illuminates the charged surface of the photoconductive drum 11 to form an electrostatic latent image (not shown) . A transfer unit 34 is disposed under the image forming units BK, Y, M, and C, and transfers the toner images of the respective colors onto the print paper. The transfer unit 34 is driven to run by a belt driving mechanism.

A developing unit 36 includes a developing roller 16, a developing blade (nth sown), and a toner supplying roller 18. The developing roller 16 supplies toner to the electrostatic latent image formed on the photoconductive drum 11. The developing blade forms a thin layer of the toner on the developing roller 15. The toner supplying roller 18 supplies the toner to the developing roller 16. The developing roller 16 is in pressure contact with the photoconductive drum 11, and rotates in an opposite direction to the photoconductive drum 11. The toner supplying roller 18 is in pressure contact with the developing roller 16, and rotates in the same direction as the developing roller 16. The photoconductive drum 11, developing roller 16, toner supplying roller 18, LED head 23 and charging roller 12 and so on form a print engine.

The photoconductive drum 11, charging roller 12, and developing unit 36 are housed in a body of the image forming unit 20. A toner cartridge 15 is detachably attached to the top of the image forming unit 20.

The transfer unit 34 includes a transfer belt 21 and transfer rollers 22. The transfer belt 21 is disposed about the transfer rollers 22 so that the transfer belt 21 is sandwiched between the photoconductive drum 11 and the transfer rollers 22. The transfer belt 21 carries the print paper thereon, and runs through the image forming units 20. The transfer belt 21 and transfer rollers 22 receive voltage from a power supply (not shown) and transfer the toner image of the respective colors from the photoconductive drums onto the print paper in sequence.

The printer 40 includes a body 38a and a top cover 38b configured to pivot about a shaft Sh1 so that the top cover 38b can be opened and closed relative to the body 38a. When the top cover 38b is closed, the top cover 38b closes the upper opening of the body 38a depicted at a plane A-A. The top cover 38b includes a stacker 31 formed on an outer surface thereof, the stacker 31 receiving the discharged sheets of print paper thereon. A paper cassette 30 is located under the transfer unit 34, and holds a stack of sheet of paper. The paper feeding mechanism 32 is disposed in the vicinity of the paper cassette 30, and feeds the print paper into the transport path on a sheet-by-sheet basis.

### {Operation of Image Forming Apparatus}

The operation of the printer 10 of the aforementioned configuration will be described.

The charging roller 12 charges the surface of the photoconductive drum 11. The LED head 23 illuminates the charged surface of the photoconductive drum 11 in accordance with the print data to form an electrostatic latent image. The developing unit 36 supplies the toner to the electrostatic latent image, thereby developing the electrostatic latent image with the toner to form a toner image.

The paper feeding mechanism feeds the sheets of print paper from the paper cassette 30 on a sheet-by-sheet basis, the sheet being transported by the transport rollers 26 and 29 to the transfer belt 21. The print paper is attracted to the transfer belt 21 by Coulomb force. As the transfer belt 21 runs through the respective image forming units BK, Y, M, and C in sequence, the toner images of the respective colors are transferred onto the print paper in registration, thereby transferring a full-color toner image onto the print paper. The print paper then advances to the fixing unit 35 where the full-color toner image is fixed into the print paper by heat and pressure. After fixing, the print paper is further transported by the transport rollers 28 and 29 and is discharged onto the stacker 31.

The printer 10 includes an interface and a controller. The interface communicates print data with an external apparatus (not shown). The controller performs the overall control of the printer 10.

### {Fixing Unit}

The fixing unit 35 will now be described.

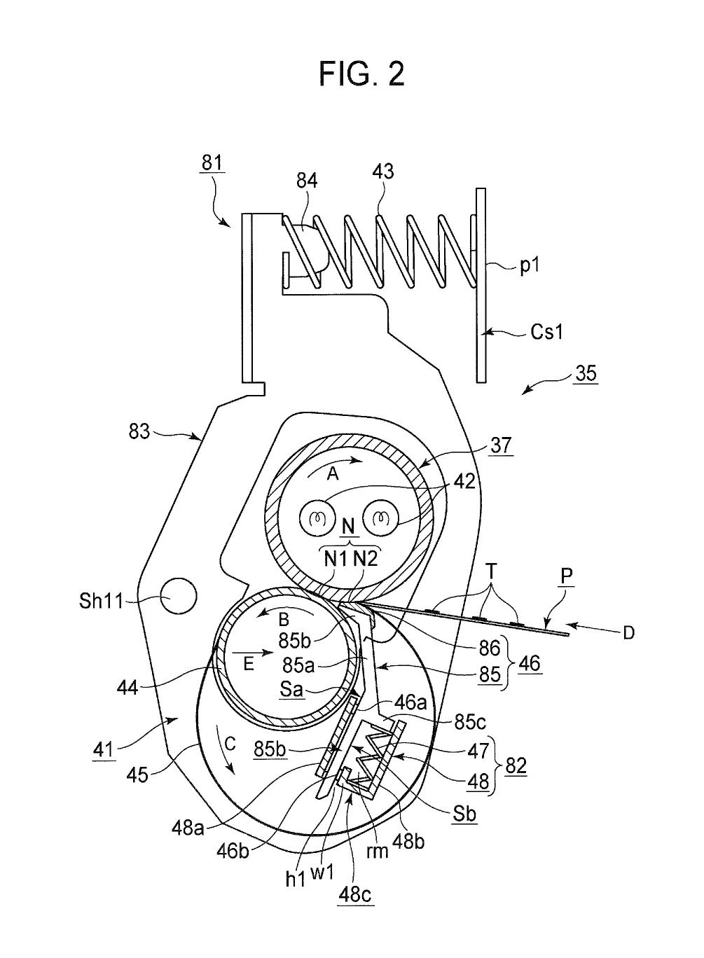

FIG. 2 is a cross-sectional view of the fixing unit 35 according to the first embodiment. Referring to FIG. 2, the fixing unit 35 includes a fixing roller 37 as a heating member and a pressure belt assembly 41. The fixing roller 37 is rotatably supported by bearings (not shown) and is driven in rotation by a fixing motor (not shown). The fixing motor is disposed on the body 40, and serves as a drive source for the fixing roller 37. The fixing roller 37 rotates at a predetermined circumferential speed in a direction shown by arrow A. A drive gear (not shown) is attached to an output shaft of the fixing motor. A driven gear (not shown) is attached to one longitudinal end portion of the fixing roller 37. The drive gear is in mesh with the driven gear, thereby transmitting the drive force to the fixing roller 37.

The fixing roller 37 is a hollow roller having an outer diameter of about 28 mm, and includes a core metal formed of iron, covered with silicone rubber. A heat resistant, elastic layer having a thickness of 1.2 mm is formed on the silicone rubber. A toner releasing layer is formed of fluoroplastic with a thickness of 41 μm, and covers the heat resistant, elastic layer. The core metal may also be formed of other metal, e.g., aluminum.

The fixing roller 37 includes built-in heaters 42. The heaters 42 are energized by a power source (not shown). A thermistor (not shown) is disposed in the vicinity of the surface of the fixing roller 37, and serves as a temperature sensor. The thermistor detects the surface temperature of the fixing roller 37, and feeds the sensor output signal to a temperature control circuit (not shown). The heater 42 may be implemented with a halogen lamp or an induction heater.

A pressure belt assembly 41 includes a pressure roller 44, a pressure belt 45, a pressure pad 46, an urging mechanism 81, and an urging mechanism 82. The pressure belt 45 is an endless belt, and runs in contact with the fixing roller 37 in a direction shown by arrow C. The pressure pad 46 is disposed upstream of the pressure roller 44 with respect to the direction in which the pressure belt 45 runs, and serves as a second pressure member. The urging mechanism 81 serves as a first urging mechanism that urges the pressure roller 44 against the fixing roller 37 with the pressure belt 45 sandwiched between the pressure roller 44 and the fixing roller 37. The urging mechanism 82 is mounted on the body 40 of the printer 10 and serves as a second pressure mechanism, urging the pressure pad 46 against the fixing roller 37 with the pressure belt 45 sandwiched between the fixing roller 37 and the pressure pad 46.

The pressure belt 45 is disposed about the pressure roller 44, pressure pad 46, and urging mechanism 82 . The pressure roller 44 and pressure pad 46 are urged against the fixing roller 37 with the pressure belt 45 sandwiched between the pressure roller 44 and the pressure pad 46. A nip N is formed between the pressure belt 45 and the fixing roller 37 so that when the print paper P passes through the nip N, the color toner image is fused by heat and pressure. As the fixing roller 37 rotates, the pressure belt 45 is rotated in the C direction due to the friction between the pressure belt 45 and the fixing roller 37, thereby transporting the print paper P.

The pressure roller 44 is a hollow roller having an outer diameter of about 23 mm, and includes a core metal formed of iron covered with silicone rubber. A covering layer formed on the core metal is formed of fluoroplastic has a thickness of 20 μm. The core metal may also be formed of other metal, e.g., aluminum.

The pressure belt 45 has a two-layer structure, and includes a diameter of about 41 mm and a thickness of about 90 μm. The two-layer structure includes a base layer formed of polyimide as a heat resistant resin and a toner releasing layer formed of perfluoroalkoxy alkane (PFA) and having a thickness of about 20 μm.

The urging mechanism 81 is disposed at each longitudinal end portion of the pressure roller 44, and includes a spring 43 and a pressure lever 83. The pressure lever 83 is rotatably supported on the shaft Sh11 so that the pressure lever 83 is rotatable relative to the chassis Cs1 of the fixing unit 35. The spring 43 urges the pressure lever 83 counter clockwise. The spring 43 is mounted across an engagement portion 84 formed at a distance from the shaft Sh11 and a pressing portion P1 on the chassis Cs. The spring 43 according to the first embodiment takes the form of a coil spring.

The pressure roller 44 is supported by bearings (not shown) and is rotatable relative to the pressure lever 83. When the spring 43 urges the pressure lever 83 to rotate counterclockwise about the shaft Sh11, the pressure roller 44 is firmly pressed against the fixing roller 37. As a result, a first nip N1 is formed on a portion of the pressure belt 45 in contact with the fixing roller 37.

In the first embodiment, the fixing roller 37 includes a heat resistant, elastic layer while the pressure roller 44 does not include a heat resistant, elastic layer but has a higher hardness than the fixing roller 37. Therefore, the fixing roller 37 elastically deforms at the first nip N1, thereby preventing the print paper P from wrapping around the fixing roller 37 to release the print paper P reliably.

The shaft Sh11 is located downstream of the nip Ni with respect to the direction of travel of the print paper P, and is adjacent to the pressure roller 44. The line passing through the rotational axes of the urging mechanism 83 and the pressure roller 44 is substantially perpendicular to the line passing through the rotational axes of the fixing roller 37 and the pressure roller 44.

The pressure pad 46 includes a base member 85, an elastic layer 86 and a low friction layer (not shown) formed on the elastic layer 86. The elastic layer 86 serves as a heat resistant, elastic layer formed at the tip of the base member 85. The pressure pad 46 holds the low friction layer in contact with the loop-like pressure belt 45 from inside so that the low friction layer is in position in the direction of travel of the print paper P. The pressure pad 46 is extendable and retractable relative to the fixing roller 37.

The base member 85 extends in such a direction as to go away from the reader and is formed in a two-stage process. A metal material, e.g., aluminum is subjected to drawing process or extrusion process, and then to press working. The elastic layer 86 is formed of silicone rubber, and has a hardness of 15 to 41 degrees when measured according to JIS-A, and a thickness of about 1 mm. The low friction layer covers the elastic layer 86 in order to reduce the friction between the inner surface of the pressure belt 45 and the elastic layer 86. The low friction layer is formed of a silicone material containing graphite, and has a thickness of 20 μm.

A longitudinally extending base member 85 includes an upper half portion 85a and a plurality of lower half portions 85d aligned along the upper half portion 85a. The lower half portions 85d extend downwardly from the upper half portion 85a. A pressing portion 85b extends from the upper end portion of the upper half portion 85a toward the first nip N1, and has a substantially triangular cross section. An abutting portion 85c extends from the middle portion of the base member 85 in such a direction as to go away from the base member 85, upstream of the base member 85 with respect to the direction of travel of the print paper P. The elastic layer 86 is disposed on the pressing portion 85b, substantially all over the upper surface of the pressing portion 85b.

The urging mechanism 82 includes a holder 48 and springs 47. The holder 48 holds the pressure pad 46 so that the pressure pad 46 parallels the fixing roller 37 and is extendable and retractable relative to the fixing roller 37. The springs 47 are aligned along the holder 48 and urge the pressure pad 46 against the fixing roller 37, thereby creating a second nip N2 in an area of the pressure pad 46 in contact with the fixing roller 37. The second nip N2 is adjacent to the first nip N1.

The springs 47 may also take the form of a resilient body or a driver member that causes the pressure pad 46 to extend and retract relative to the fixing roller 37.

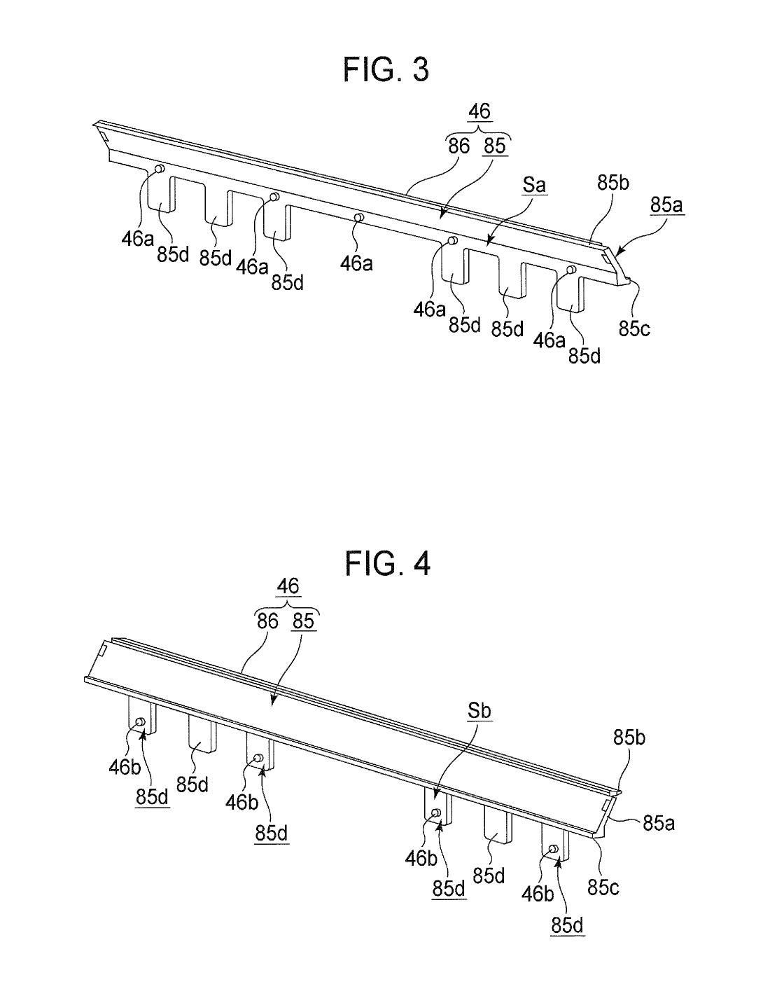

FIG. 3 is a rear perspective view illustrating the rear of a pressure pad 46 as seen substantially in a direction shown by arrow E in FIG. 2. FIG. 4 is a perspective view illustrating the front of the pressure pad as seen substantially in the opposite direction to arrow E.

Referring to FIG. 3, a plurality of cylindrical projections 46a are formed in one piece construction with the base member 85 on a surface Sa of the base member 85 that faces the inner wall 48a of the holder 48. A plurality of projections 46b (second projections) are formed on a surface Sb of the lower half portion 85d that faces the wall w1. The projections 46a are slidable on the inner wall 48a, and the projections 46b are slidable on the wall w1. The projections 46a and 46b are formed by pressing work.

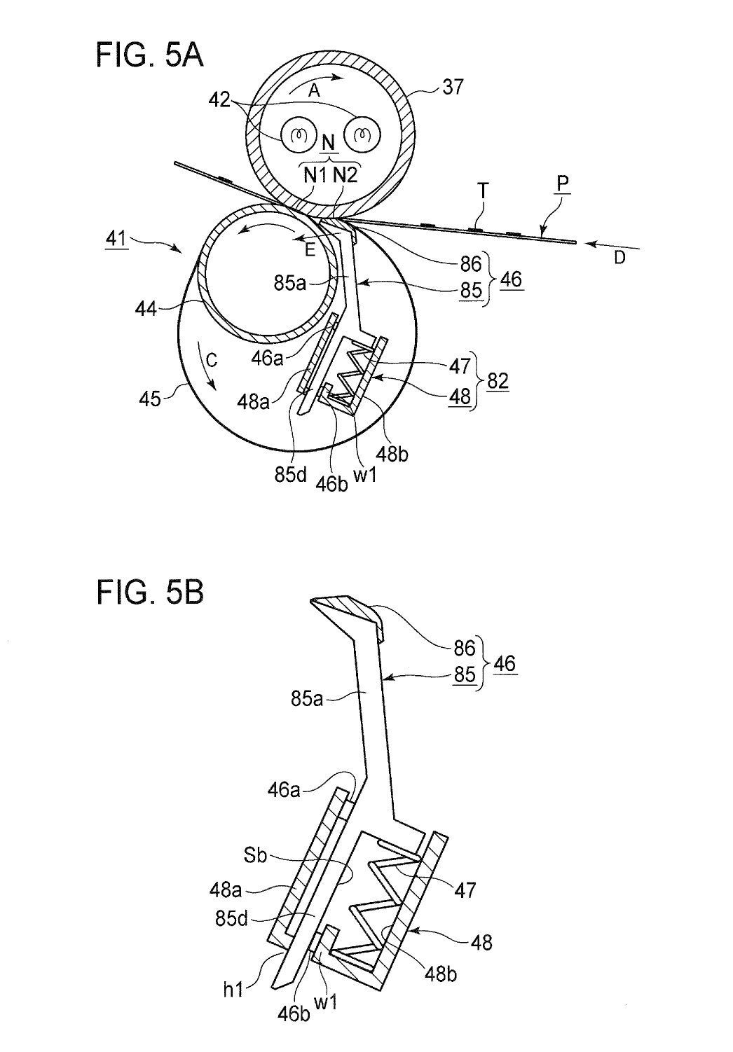

FIG. 5A illustrates the operation of the fixing unit 35 according to the first embodiment. FIG. 5B illustrates a pertinent portion of the fixing unit.

Referring to FIGS. 5A and 5B, the holder 48 is formed of a metal material and has a gutter-like hollow body which has a generally U-shaped cross section and is open at its upper end. The holder 48 is mounted on the chassis of the printer 10 and is disposed close to the pressure roller 44. The holder 48 receives the abutting portion 85c and the lower half portions 85d therein so that the abutting portion 85c and the lower half portions 85d are slidable on the inner walls 48a and 48b, and 48c. The inner walls 48a, 48b, and 48c define a room that accommodates the abutting portion 85c, lower half portions 85d, and the springs 47 therein. The springs 47 are disposed between a bottom wall 48c and the abutting portion 85c.

Holes h1 are formed in the bottom wall 48c near the inner wall 48a, allowing the lower half portions 85d to extend through the holes h1. A wall w1 rises from the bottom wall 48c to cooperate with the inner wall 48a to define a groove therebetwen.

Since the base member 85 and holder 48 are formed of metal materials, the holder 48 may be connected to the ground so that the charges on the base member 85 are dissipated and the base member 85 is prevented from acting as an antenna that radiates electrical noise.

As the pressure belt 45 runs in the C direction, a frictional resistance is developed between the inner surface of the pressure belt 45 and the elastic layer 86, which causes the pressure pad 46 to incline, vibrate, or rattle. When the pressure pad 46 inclines, vibrates, or rattles, the lower half portions 85d of the pressure pad 46 and the inner wall of the holder 48 move into contact with each other.

Excessive temperatures of the pressure pad 46 and the holder 48 will lead to increased friction at their interface, which may result in seizure of the pressure pad 46 in a high temperature environment and fail to reliably urge the pressure pad 46 against the fixing roller 37. The seizure of the pressure pad 46 causes damaged images, positional shifts of images, and uneven image quality, leading to deteriorated image quality, increasing the load on the fixing motor, or even causing complete stoppage of the fixing unit.

Referring to FIG. 5B, when the pressure pad 46 abuts the projections 46a and the pressure mechanism 82 abuts the projections 46b, and the pressure pad 46 extends and retracts relative to the pressure belt 45, the projections 46a slide on the inner wall 48a and the projections 46b slide on the wall w1.

In the first embodiment, the lower half portions 85d and projections 46a and 46b are formed along the upper half portion 85a in a direction perpendicular to the direction of travel of the print paper P. The number of the lower half portions 85d and projections 46a and 46b may be selected so that the printer 10 is capable of printing on the print paper P of a variety of sizes including A5, A4 and A3 sizes.

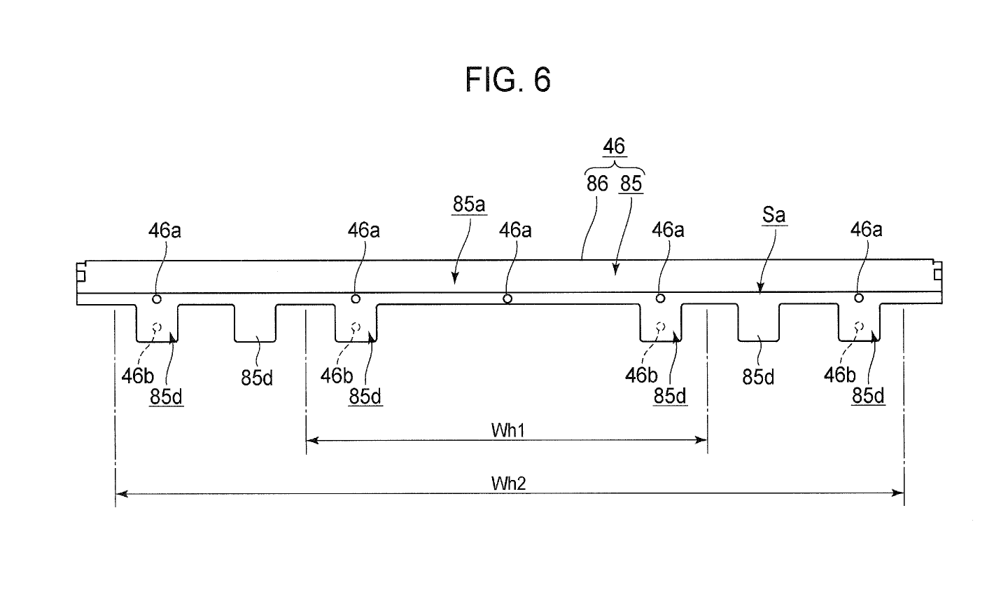

FIG. 6 is a rear view of the pressure pad. The printer 10 according to the present invention supports A5, A4, and A3 size paper. The A5 size print paper P has a width Wh1 (148 mm) and the A3 size print paper P has a width Wh2 (297 mm). Two laterally centered first lower half portions 85d are disposed within the width Wh2. Two laterally centered second lower half portions 85d are disposed between the two laterally centered first lower half portions 85d. Two laterally centered third lower half portions 85d are disposed between the two laterally centered second lower half portions 85d. One projection 46a, shown in solid line, is formed substantially at the longitudinal middle of the upper half portion 85a. Each of four projections 46a, shown in solid lines, is formed on the surface Sa immediately above a corresponding one of the first and third lower half portions 85d. Each of four projections 46b, shown in dotted lines, is formed on the surface Sb of a corresponding one of the first and third lower half portions 85d. When printing is performed on A5 size paper, the A5 size paper is advanced in the area Wh1. When printing is performed on A3 size paper, the A3 size paper is advanced in the area Wh2.

The projections 46a and 46b have been described in terms of a cylindrical shape but may take the form of a rib.

### {Operation of Fixing Unit}

The operation of the fixing unit 35 will be described with reference to FIGS. 5A and 5B.

When the printer 10 starts printing, the fixing motor is energized to drive the fixing roller 37 into rotation, the fixing roller 37 causing the pressure belt 45 to run by means of the frictional force developed at the nip N between the pressure belt 45 and the fixing roller 37.

The heaters 42 are energized by the power supply to generate heat, which in turn heats the fixing roller 37 from inside. The power supply adjusts the amount of current supplied to the heater in accordance with the output of the thermistor, thereby controlling the temperature of the fixing roller 37 to a predetermined temperature.

When the temperature of the fixing roller 37 has reached the predetermined temperature, the print paper P is fed into the nip N. As the pint paper P passes through the nip, i.e., nips N1 and N2, the toner image T on the print paper P is fused by heat and pressure into a permanent image. After fixing, the print paper P is discharged outside the chassis Cs1 through a discharge port (not shown).

When the fixing roller 37 rotates in the A direction and the pressure belt 45 is driven to run in the C direction, a force acts on the pressure pad 46 in the E direction so that the pressure pad 46 inclines, causing the lower end portion 46a of the upper half portion 85a to press the inner wall 48a, and the lower end portion 46b of the lower half portion 85d to press the wall w1. Since the projections 46a and 46b have a small surface area, the contact area between the inner wall 48a and the upper half portion 85a and the contact area between the wall w1 and the lower half portion 85d are small.

When the print paper P is fed into the nip N, the pressure pad 46 retracts into the holder 48 in accordance with the thickness of the print paper P. At this time, the small contact areas between the pressure pad 46 and the holder 48 can be small enough.

As described above, the. projections 46a and 46b serve to reduce the contact area between the inner wall 48a and the projection 46a, and the contact area between the wall w1 and the projection 46b, reducing the frictional resistance developed between the pressure pad 46 and the holder 48.

As a result, seizure of the pressure pad 46 does not occur in the holder 48 even if the pressure pad 46 inclines, vibrates, or rattles. This helps the pressure pad 46 urge the fixing roller 37, preventing the printed image from suffering from damaged images, shifted images, and uneven image quality, leading to deteriorated image quality and increasing the load on the fixing motor or even complete stoppage of the fixing unit.

The projections 46a are formed on the lower end portion of the upper half portion 85a so that the area of the base member 85 in pressure contact with the wall 48a may be small and the projections 46b are formed on the lower end portion of the lower half portion 85d so that the area of the base member 85 in pressure contact with the inner wall w1 may be small. This minimizes the total contact area of the base member 85 with the holder 48 so that the frictional resistance between the pressure pad 46 and the holder 48 is small when the base member 85 extends and retracts within the holder 48.

The projections 46a may also be formed at arbitrary locations where the lower half portion 85d faces the inner wall 48a. Still alternatively, the projections 46b may be formed at arbitrary locations on the surface Sb (FIGS. 2 and 4) of the lower half portion 85d.

Also, instead of the projections 46a and 46b, projections may be formed either on the inner wall 48a and the wall w1 or on the base member 85, inner wall 48a, and wall w1.

### Second Embodiment

Elements similar to those of the first embodiment have been given similar reference numerals and their description is omitted.

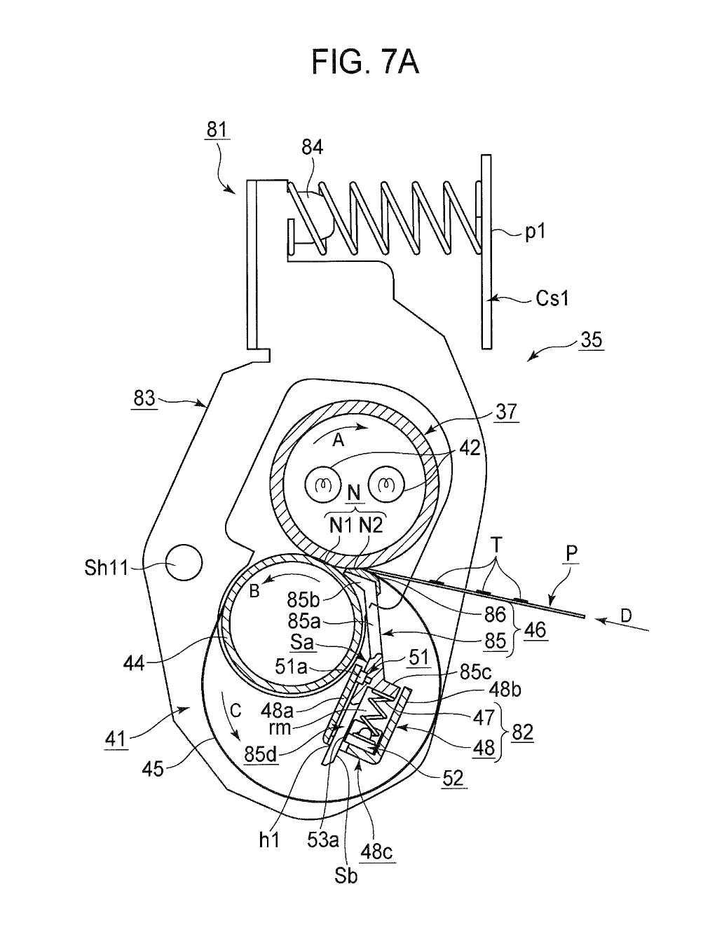

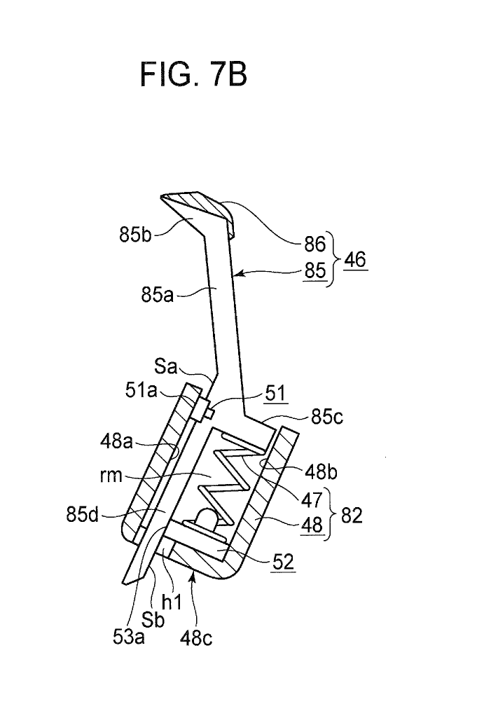

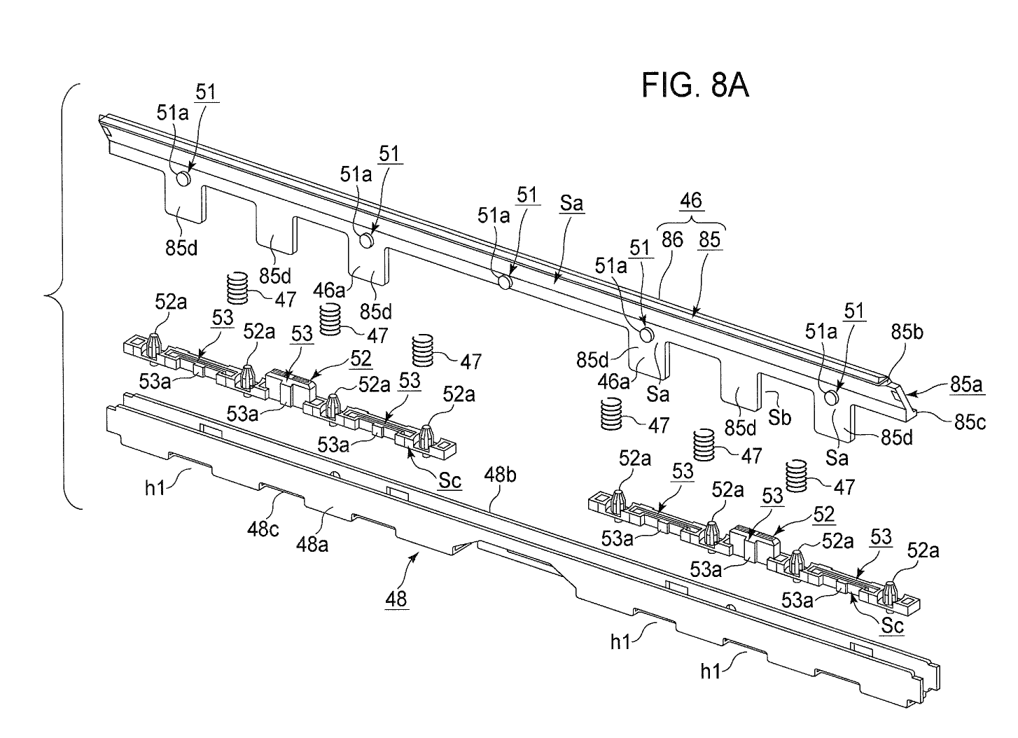

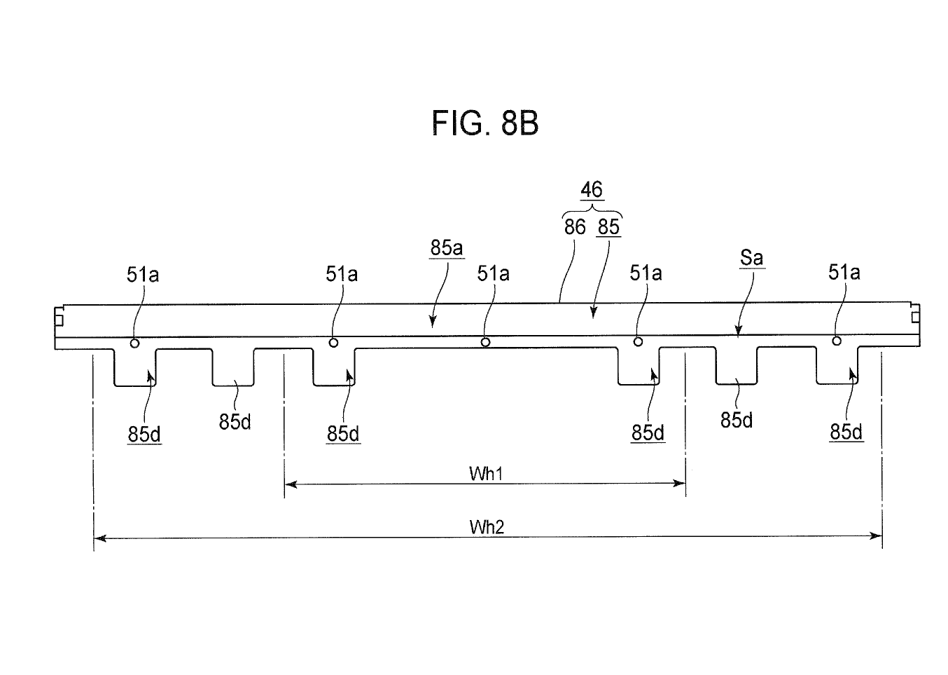

FIG. 7A is a cross-sectional view of a fixing unit according to a second embodiment. FIG. 7B is an expanded view of a pertinent portion of the fixing unit. FIG. 8A is an exploded perspective view illustrating a pressure pad, springs, and holder according to the second embodiment.

A longitudinally extending base member 85 includes an upper half portion 85a, a pressing portion 85b, an abutting portion 85c, and a plurality of lower half portions 85d. The lower half portions 85d extend downwardly from the upper half portion 85a. The pressing portion 85b extends from the upper end portion of the upper half portion 85a toward a first nip N1 and has a substantially triangular cross section. The abutting portion 85c horizontally extends from a middle portion of the base member 85 in such a direction as to go away from the base member 85, upstream of the base member 85 with respect to the direction of travel of the print paper P. A heat resistant, elastic layer 86 is disposed on the pressing portion 85b substantially all over the upper surface of the pressing portion 85b.

The urging mechanism 82 includes a holder 48 and springs 47. The holder 48 holds the pressure pad 46 therein so that the pressure pad 46 parallels the fixing roller 37 and is extendable and retractable relative to the fixing roller 37. The springs 47 are disposed in the holder 48 along the holder 48 and urge the pressure pad 46 against the fixing roller 37.

The holder 48 is formed of a metal material and has a gutter-like hollow body which has a generally U-shaped cross section and is open at its upper end. The holder 48 is disposed close to the pressure roller 44. The holder 48 receives the abutting portion 85c and the lower half portions 85d therein so that the abutting portion 85c and the lower half portions 85d are slidable on opposing inner walls 48b and 48a. The inner walls 48a and 48b and a bottom wall 48c define a room that accommodates the abutting portion 85c, the lower half portion 85d, and the springs 47 therein. The springs 47 are disposed between a bottom wall 48c and the abutting portion 85c.

Holes h1 are formed in the bottom wall 48c near the inner wall 48a, allowing the lower half portions 85d to extend therethrough. A wall w1 rises from the bottom wall 48c, cooperating with the inner wall 48a to define a narrow groove between the wall w1 and the inner wall 48a in which the lower half portions 85d are sandwiched and are slidable.

As the pressure belt 45 runs in a direction shown by arrow C, a frictional resistance is developed between the inner surface of the pressure belt 45 and the elastic layer 86, which causes the pressure pad 46 to incline, vibrate, or rattle. When the pressure pad 46 inclines, vibrates, or rattles, the lower half portions 85d of the pressure pad 46 and inner wall of the holder 48 move into contact with each other.

Excessive temperatures of the pressure pad 46 and the holder 48 will lead to increased friction at their interface, which may result in seizure of the pressure pad 46 in a high temperature environment and fail to reliably urge the pressure pad 46 against the fixing roller 37.

In the second embodiment, a plurality of projections 51 are disposed on a surface Sa of the lower portion of upper half portion 85a facing the inner wall 48a. The projections 51 are a cylinder of a resin with a large diameter portion and a small diameter portion. The projections 51 are press-fitted into the surface Sa so that a surface 51a of the large diameter portion projects from the surface Sa.

Referring to FIG. 8A, the holder 48 accommodates abutting members 52 as a second sliding member, which are slidable in contact with the base member 85 and holds the base member 85 between the wall 48a and the abutting member 52. The abutting members 52 are formed of a resin material, and are disposed at a plurality of locations (two locations in the second embodiment) on the bottom wall 48c and beside the lower half portions 85d, and aligned in the longitudinal direction of the holder 48. Each of the abutting members 52 has four upwardly extending spring supporting projections 52a, and a spring 47 fits over a corresponding spring supporting projection 52a. Each spring 47 is disposed between the supporting projections 52a and the abutting portion 85c.

The abutting member 52 includes a surface Sc that faces the lower half portion 85d and is located between adjacent supporting projections 52a. A plurality of projections 53 are a cube or a rectangular parallelepiped of a resin material. The projections 53 are press-fitted into the surface Sc so that the projection 53 partially projects from the surface Sc. Projected surfaces 53a of the projections 53 project from the surface Sc and are in the shape of a rectangular parallelopiped. When the pressure pad 46 extends out of and retracts into the holder 48, the projections 51a slide on the inner wall 48a and the projected surfaces 53a slide on the lower portion of the lower half portion 85d.

In the second embodiment, the number of the lower half portions 85d and projections 51a and projected surfaces 53a is selected to support a variety of paper sizes including A5, A4, and A3 sizes.

FIG. 8B is a rear view of the pressure pad according to the second embodiment. The printer 10 according to the present invention supports A5, A4, and A3 size paper. Two laterally centered first lower half portions 85d are disposed within the width Wh2. Two laterally centered second lower half portions 85d are disposed between the two laterally centered first lower half portions 85d. Two laterally centered third lower half portions 85d are disposed between the two laterally centered second lower half portions 85d. Each of four projected surface 51a is formed on the surface Sa of the upper half portion 85a immediately above a corresponding one of the laterally centered first and third lower half portions 85d. One projected surface 51a is formed at the longitudinal middle of the upper half portion 85a. Each of four projected surfaces 53a is formed on the surface Sc of a corresponding one of two abutting members 52. When printing is performed on A5 size paper, the A5 size paper is advanced in the area Wh1. When printing is performed on A3 size paper, the A3 size paper is advanced in the area Wh2.

The projections 51 and 53 are formed of a heat resistant resin that can withstand the temperature at which the fixing unit 35 operates. The heat resistant resin is preferably electrically conductive so that the charges developed on the base member 85 can be dissipated. If the charges on the base member 85 can be conducted to surrounding members in some way, the projections 51 and 53 need not be formed of an electrically conductive resin.

In the second embodiment, the projected surface 51a is formed on the lower portion of the upper half portion 85a. Instead, the projected surface 51a may be formed at an arbitrary position on the surface of the lower half portion 85d that faces the inner wall 48a. For example, the projected surface 51a may be formed on the lower end portion of the lower half portions 85d.

In the second embodiment, the projected surface 51a is formed on the base member 85 and the projected surface 53a is formed on the abutting member 52. Instead, projections may be formed on the inner wall 48a of the holder 48 and the surface Sb of the lower half portion 85d.

The projected surface 51a reduces the area of the upper half portion 85a in contact with the inner wall 48a and the projected surface 53a reduces the area of the lower half portion 85d in contact with the abutting member 52. This configuration reduces the friction resistance developed between the pressure pad 46 and the holder 48 when the pressure pad 46 extends and retracts within the holder 48.

When the projected surfaces 51a and 53a formed of a resin material rub on the inner wall 48a and lower half portion 85d, respectively, the friction resistance between the pressure pad 46 and the holder 48 is relatively small. Even when the pressure pad 46 inclines, vibrates, or rattles, seizure of pressure pad will not occur in a high temperature environment, preventing damaged images, positional shifts of images, and uneven image quality that would otherwise lead to deteriorated image quality. Further, the load on the fixing motor that drives the fixing roller 37 is minimized, preventing complete stoppage of the fixing unit.

When the pressure pad 46 inclines, the lower end portion, i.e., projected surface 51a of the upper half portion 85a is pressed against the inner wall 48a, and the projected surface 53a of the abutting member 52 is pressed against the lower end portion of the lower half portion 85d. Therefore, the areas of the base member 85 in contact with the holder 48 and abutting member 52 may be sufficiently small. This further minimizes the friction resistance between the abutting member 52 and the pressure pad 46 and the friction resistance between the pressure pad 46 and the holder 48.

### Third Embodiment

Elements similar to those of the first and second embodiments have been given the same reference numerals and their description is omitted.

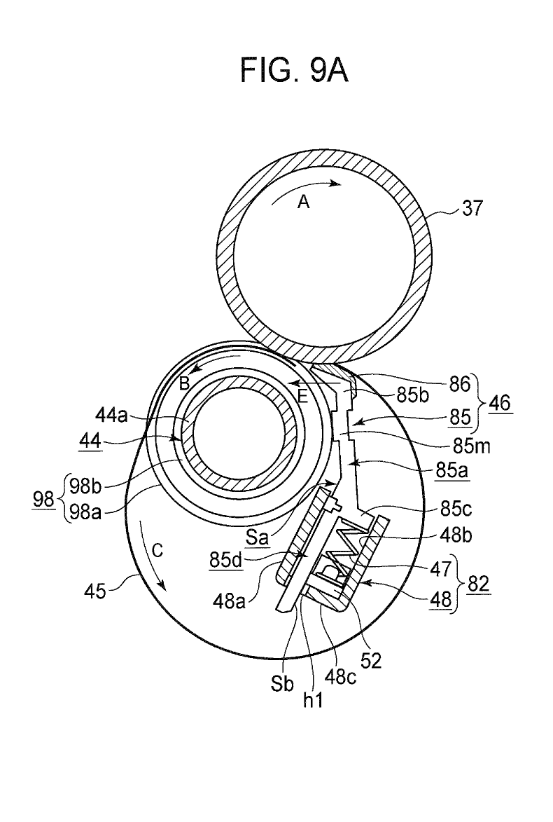

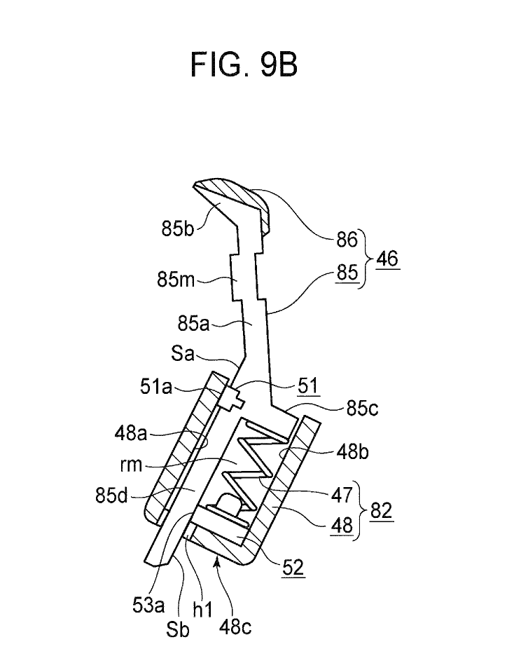

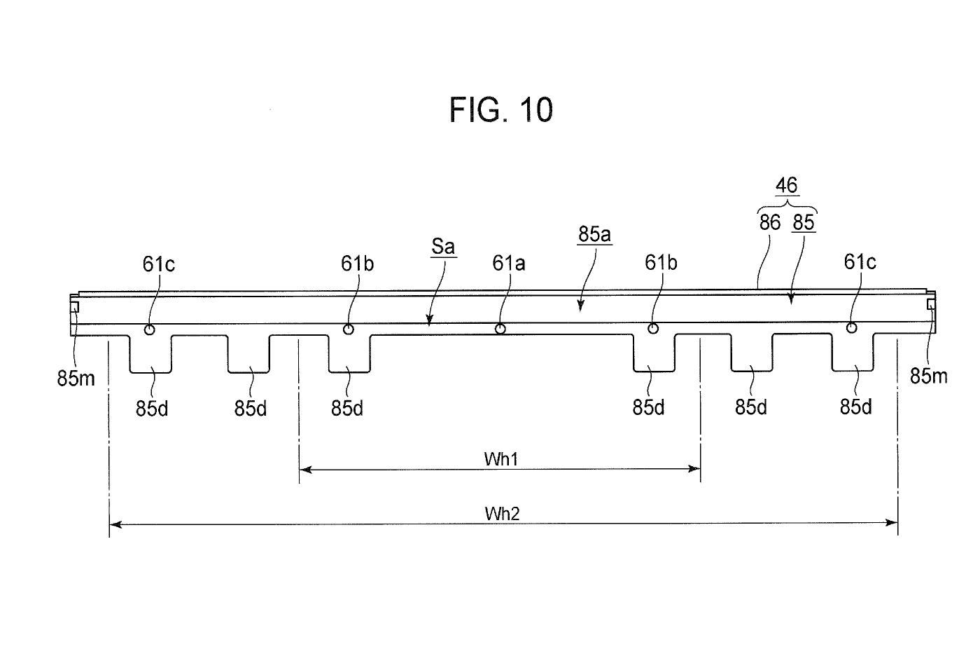

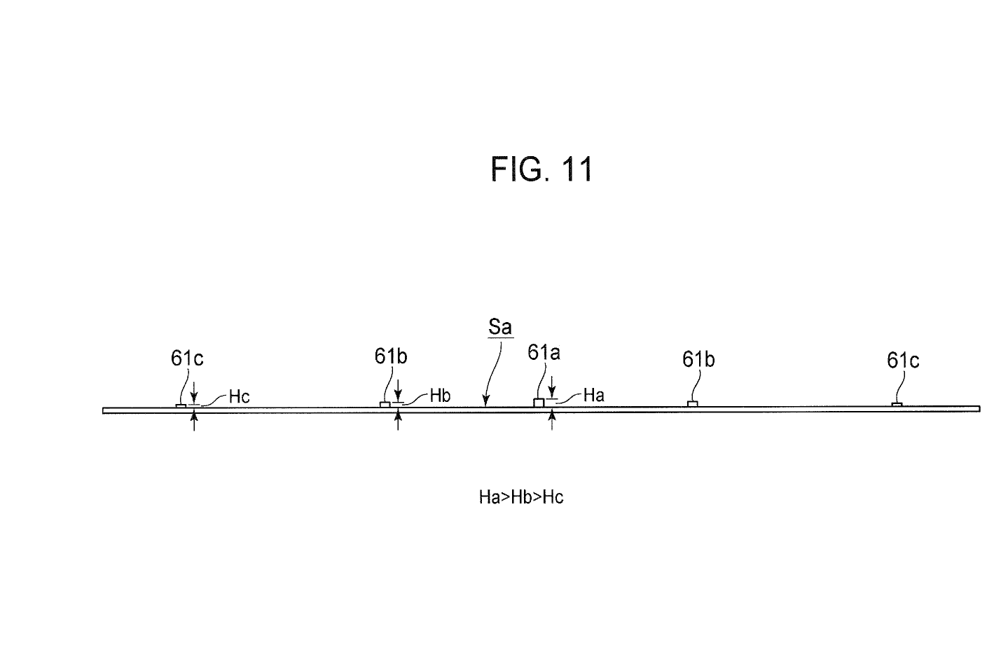

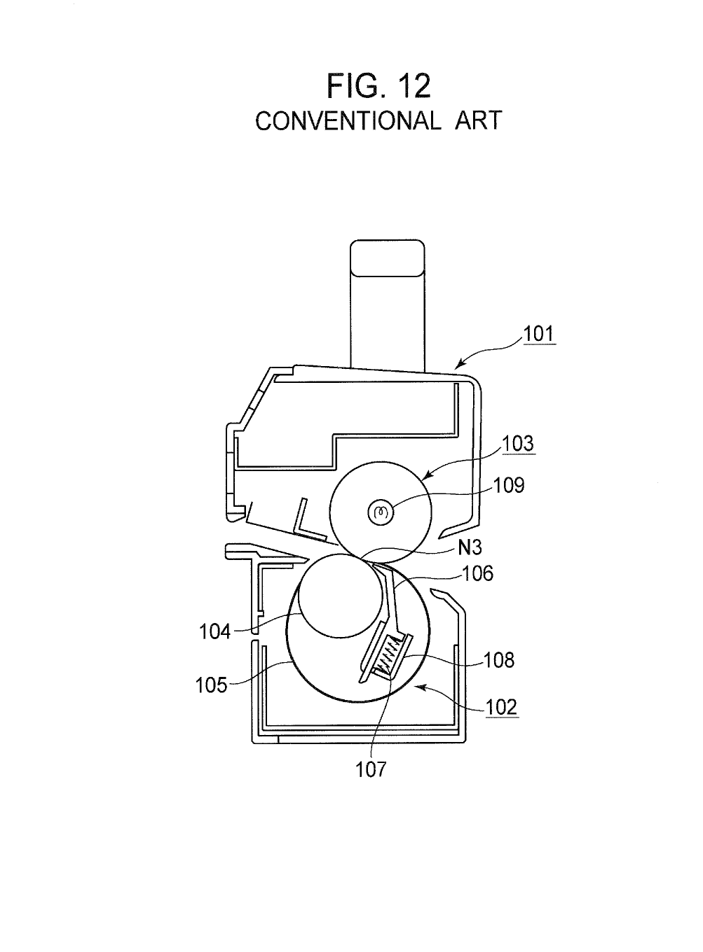

FIG. 9A is a cross-sectional view illustrating the pertinent portion of a fixing unit 35 according to a third embodiment. FIG. 9B is an expanded view of a pertinent portion of the fixing unit 35. FIG. 10 is a front view of a pressure pad according to the third embodiment. FIG. 11 is a cross-sectional view of anther pressure pad.

Referring to FIG. 9A, bearings 98 each include an outer lace 98a and an inner race 98b. The shaft 44a of a pressure roller 44 is fitted into the inner race 98b.

Referring to FIG. 10, a plurality of projections 61a-61c in the shape of a cylinder are formed on a surface Sa of the base member 85, the surface Sa facing an inner wall 48a of a holder 48.

In order for the printer 10 to support a variety of paper sizes including A5, A4, and A3 sizes, the number of lower half portions 85d and projections 61-61c disposed along the longitudinal direction of the pressure pad 46 may be selected in accordance with the paper size to support.

In the third embodiment, the number of the lower half portions 85d and projections 61a-61c is selected to support a variety of paper sizes including A5, A4, and A3 sizes. Six lower half portions 85d are disposed within the width Wh2 of the paper. Two laterally centered first lower half portions 85d are disposed within the Wh2. Two laterally centered second lower half portions 85d are formed between the two laterally centered first lower half portions 85d. Two laterally centered third lower half portions 85d are formed between the two laterally centered second lower half portions 85d. One projection 61a is formed on the surface Sa and substantially at the longitudinal middle of the upper half portion 85a. Each of two projections 61c is formed on the surface Sa immediately above a corresponding one of the two laterally centered first lower half portions 85d. Each of another two projections 61b is formed on the surface Sa immediately above a corresponding one of the two laterally centered second lower half portions 85d. When printing is performed on A5 size paper, the A5 size paper is advanced in the area Wh1. When printing is performed on A3 size paper, the A3 size paper is advanced in the area Wh2.

The outer race 98a of the bearing 98 that rotatably supports the pressure roller 44 abuts projections 85m formed at both longitudinal end portions of the upper half portion 85a, creating a clearance between the pressure roller 44 and a pressing portion 85b of the base member 85 so that the base member 85 does not interfere with the pressure roller 44. Thus, the pressure pad 46 is supported at its longitudinal end portion by the projections 85m.

When the fixing roller 37 rotates in a direction shown by arrow A and the pressure belt 45 runs in a direction shown by arrow C, the friction resistance between the inner surface of the pressure belt 45 and the surface of the elastic layer 86 exerts a force on the pressure pad 46 that acts in a direction shown by arrow E. Since the pressure pad 46 is supported at its longitudinal end portions by the projections 85m, the lower end portion of the upper half portion 85a is firmly pressed against the inner wall 48a and the lower end portions of the lower half portions 85d are firmly pressed against the abutting member 52. The pressing force decreases with increasing distance from the longitudinal end portions of the pressure pad 46.

It is to be noted that if the pressure pad 46 fails to press the fixing roller 37 uniformly across the length of the fixing roller 37, non-uniform pressing force causes distorted images, shifted images, and uneven density of images, leading to degraded image quality.

In the third embodiment, the projections 61a-61c are formed with different heights from the surface Sa in accordance with the positions of the projections 61a-61c in the longitudinal direction. The projections 61a-61c are higher nearer the longitudinally middle portion of the pressure pad 46, and therefore lower further away from the middle portion. The heights of the projections 61a-61c are related as follows:

Ha>Hb>Hc

where Ha is the height of the projection 61a, Hb is the height of the projection 61b, Hc is the height of the projection 61c.

The selection of height of the projections 61a-61c allows the pressure pad 46 to press the fixing roller 37 uniformly across the length of the fixing roller 37, thus preventing distorted images, shifted images, and uneven density of images to provide good image quality.

The aforementioned configuration, in which the projections 61a-61c are higher nearer the middle portion of the pressure pad 46, may also be applied to the second embodiment.

The first to third embodiments have been described in terms of a tandem printer 10 that incorporates black, yellow, magenta and cyan image forming units aligned in tandem, the present invention may also be applied to a variety of image forming apparatus including a mono color printer, a copying machine, a facsimile machine, and a multifunction printer.

The invention is not limited to the described the embodiments, and may be modified in a variety of ways without departing from the scope of the invention.

What is claimed is:

1. A fixing apparatus, comprising:
a rotatably supported fixing member;
a first pressing member disposed to face the fixing member;
a running member sandwiched between the fixing member and the first pressing member, and running when the fixing member rotates;
a first pressing mechanism that urges the first pressing member against the fixing member so that a first nip is defined between the fixing member and the running member;
a second pressing member disposed to face the fixing member with the running member sandwiched between the fixing member and the second pressing member; and
a second pressing mechanism that urges the second pressing member against the fixing member with the running member sandwiched between the fixing member and the second pressing member so that a second nip is defined between the fixing member and the running member, the second nip being adjacent to the first nip;
wherein the second pressing mechanism includes a holding member that holds the second pressing member and an urging member therein, the urging member urging the second pressing member against the fixing member; and
wherein the second pressing member and the holding member abut each other through a plurality of projections formed on at least one of the second pressing member and second pressing mechanism.

2. The fixing apparatus according to claim 1, wherein the fixing member longitudinally extends in a first direction, the second pressing member longitudinally extends in a second direction substantially parallel to the first direction, and the projections are aligned along the second direction.

3. The fixing apparatus according to claim 2, wherein the plurality of projections are aligned in the second direction and have different heights from one another.

4. The fixing apparatus according to claim 3, wherein the plurality of projections have larger heights nearer a longitudinal middle of the fixing member.

5. The fixing apparatus according to claim 1, wherein when the running member runs, the second pressing member is pressed against the holder through the projections.

6. The fixing apparatus according to claim 1, wherein at least one of the second pressing member and the holding member is formed of a metal material and the abutting member is formed of a resin material.

7. The fixing apparatus according to claim 6, wherein the resin material is electrically conductive.

8. The fixing apparatus according to claim 1, wherein the projections are formed in one piece with at least one of the second pressing member and the holding member.

9. The fixing apparatus according to claim 1, further comprising an abutting member received in the holding member and slidable within the holding member, wherein the projections are formed on the abutting member.

10. An image forming apparatus incorporating the fixing apparatus according to claim 1, wherein the image forming apparatus comprising:
at least one image forming sections that forms a developer image on an image bearing body; and
a transfer device that transfers the developer image onto a medium.
